(19) United States
(12) Patent Application Publication
(10) Pub. No.: US 2003/0149982 A1
(43) Pub. Date: Aug. 7, 2003

(54) Program list display system

(76) Inventors: Yasuo Nakashima, Kobe (JP); Minoru Maehata, Kobe (JP); Mitsuru Sasaki, Kobe (JP); Hideshi Nishizawa, Kobe (JP); Masahiro Kamiya, Kobe (JP); Hideki Nakamura, Kobe (JP); Masahiko Kitagawa, Kobe (JP)

Correspondence Address: WENDEROTH, LIND & PONACK, L.L.P., 2033 K STREET N. W., SUITE 800, WASHINGTON, DC, 20006-1021, US

(21) Appl. No.: 10/357,474

(22) Filed: Feb. 4, 2003

(30) Foreign Application Priority Data
Feb. 4, 2002 (JP) 2002-26621

(51) Int. Cl. H04N 5/445

(52) U.S. Cl. 725/47; 725/45; 725/46

(57) ABSTRACT

The present invention was achieved in order to provide a program list display system for television broadcasting to display an appropriate and useful program list even if unreceived program data is present, comprising a program data receiving device to receive program data of television broadcasts, a program list making device to make a program list based on the program data received by the program data receiving device, and a display driving device to display the program list made by the program list making device on a display, which has an unreceived slot image formation device to form an unreceived slot image in an unreceived program slot which is a display area of the program list corresponding to an unreceived program whose program data has not been received so as to make a program list.

### BACKGROUND OF THE INVENTION

1. Field of the Invention

The present invention relates to a program list display system whereby program data of television broadcasts are received so as to display a program list and, more particularly, to a program list display system having a technique for conducting display processing of time periods (program slots) whose program data have not been received.

2. Description of the Relevant Art

When a viewer selects a television program to watch, he/she usually selects one with checking its program contents (program title, outline, performers and the like) in a program list contained in a newspaper or a television program magazine. Recently, however, program data have been provided through data broadcasting such as digital broadcasting, the Internet or the like with the spread of them, so that a program list display system to display an electronic program list, called an EPG (Electronic Program Guide) on a display such as a television screen has also been realized, and has been included in, for example, more television sets.

However, a conventional EPG is displayed by receiving program data over a prescribed period so as to form a program list picture, leading to a long time for display. As a result, users of the television sets feel dissatisfied therewith.

### SUMMARY OF THE INVENTION

The present invention was accomplished in order to solve the above problem, and it is an object of the present invention to provide a program list display system which can display a program list in a short time, and display an appropriate and useful program list, even if unreceived program data is present.

In order to achieve the above object, a program list display system (1) according to the present invention is characterized by being a program list display system, comprising a program data receiving device to receive program data of television broadcasts, a program list making device to make a program list based on the program data received by the program data receiving device and a display driving device to display the program list made by the program list making device on a display device, wherein the program list making device comprises an unreceived slot image formation device to form an unreceived slot image in an unreceived program slot which is a display area of the program list corresponding to an unreceived program whose program data has not been received so as to make a program list.

Using the above program list display system (1), by forming an unreceived slot image as to an unreceived program whose program data has not been received, a program list is made and displayed. Therefore, the program list is swiftly displayed, though it is not perfect, and then the program list gradually becomes perfect. As a result, users can grasp an overview of the program schedule quickly and obtain program information they want earlier than (at least at the same time as) when the data of all programs are received, leading to users'convenience.

A program list display system (2) according to the present invention is characterized by the unreceived slot image, which is a picture filled in with a single color in the above program list display system (1).

Using the above program list display system (2), a program whose program data has not been received yet is easily found, and the time relationship between each program can be known quickly.

A program list display system (3) according to the present invention is characterized by the unreceived slot image, which is a television broadcast picture in the above program list display system (1).

Using the above program list display system (3), it becomes possible to actually display a television program through the effective use of a program slot having no program information, leading to a convenience for confirming program contents and the like.

A program list display system (4) according to the present invention is characterized by comprising a display form changing device to differentiate a display form of an unreceived program slot which is altered to a received program slot from that of other received program slots, when the unreceived program slot is altered to the received program slot which is a display area of the program list corresponding to a received program whose program data has been received, based on new program data received by the program data receiving device in any of the above program list display systems (l)-(3).

Using the above program list display system (4), a program slot portion whose display contents have been altered can be easily found, so that it becomes easy to confirm program information.

A program list display system (5) according to the present invention is characterized by the unreceived slot image, which is formed based on data of a received program which broadcasts the same event in the above program list display system (1), (2) or (4).

Using the above program list display system (5), even the outline of a program whose program data has not been received is displayed using program data of another program which is broadcasting the same event such as the same game in sports, or the like, so that it becomes possible to swiftly display a program list which is closer to its perfect state.

A program list display system (6) according to the present invention is characterized by the unreceived slot image, which is formed based on program data of one part of a serial program in another time period, when the serial program broadcasts an event in parts in point of time in the above program list display system (1), (2) or (4).

Using the above program list display system (6), even the outline of a program whose program data has not been received is displayed using program data of a serial (broadcast) at another date in a serial program such as a serial drama which broadcasts the same event in parts in point of time, so that it becomes possible to swiftly display a program list which is closer to its perfect state.

A program list display system (7) according to the present invention is characterized by comprising a serial program display form changing device to differentiate a display form of a program slot corresponding to the unreceived slot image from that of other program slots, when the unreceived slot image is formed based on program data of one part of a serial program in another time period in the above program list display system (6).

Using the above program list display system (7), the conditions (reliability and the like) of displayed program data can be grasped, so that users can carry out an appropriate confirmation and the like as necessary.

A program list display system (8) according to the present invention is characterized by comprising a program data storage device to store program data, and a serial program detecting device to detect a serial program based on the program data stored in the program data storage device in the above program list display system (1), (2) or (4).

Using the above program list display system (8), it becomes possible to automatically detect a serial program with high accuracy by analyzing trends in the program schedule, for example, the broadcast times and the days of the week of programs whose program titles are basically the same (only parts thereof such as the ordinal numbers are sometimes different) based on the past broadcast records (the program data received in the past).

A program list display system (9) according to the present invention is characterized by comprising a program data storage device to store program data, and an unreceived slot image predictive formation device to predict and form the unreceived slot image based on the program data stored in the program data storage device and the date and time of the unreceived slot in the above program list display system (1), (2) or (4).

Using the above program list display system (9), it becomes possible to predict a program in an unreceived slot with high accuracy by analyzing trends in the program schedule, for example, the broadcast times and the days of the week of programs whose program titles are basically the same (only parts thereof such as the ordinal numbers are sometimes different) based on the past broadcast records (the program data received in the past).

A program list display system (10) according to the present invention is characterized by the unreceived slot image predictive formation device, which predicts and forms the unreceived slot image based on the latest program data stored in the data storage device in the above program list display system (9).

Using the above program list display system (10), a program in an unreceived slot is predicted based on newer program data, so that it becomes possible to predict program information with higher accuracy.

A program list display system (11) according to the present invention is characterized by the unreceived slot image predictive formation device, which predicts and forms the unreceived slot image based on program data of a program at the same hour a prescribed number of days before the date of the unreceived slot in the above program list display system (9) or (10).

Using the above program list display system (11), the program prediction suits the program schedule in which programs actually tend to be repeated at fixed periods (every day, every week or the like), so that it becomes possible to predict a program with higher accuracy.

A program list display system (12) according to the present invention is characterized by the prescribed number of days, which is determined according to the time period of the unreceived slot in the above program list display system (11).

Using the above program list display system (12), the program prediction suits the program schedule in which the broadcast periods (every day, every week or the like) actually tend to be determined depending on time periods, so that it becomes possible to predict a program with higher accuracy.

A program list display system (13) according to the present invention is characterized by the display form of the unreceived slot, which is different from that of the received slot in any of the above program list display systems (1)-(12).

Using the above program list display system (13), the conditions (reliability and the like) of displayed program data can be grasped, so that users can carry out an appropriate confirmation and the like as necessary.

A program list display system (14) according to the present invention is characterized by the unreceived slot image, which includes a mark showing that the program is an unreceived program in any of the above program list display systems (1)-(13).

Using the above program list display system (14), the conditions (reliability and the like) of displayed program data can be grasped through the mark, so that users can carry out an appropriate confirmation and the like as necessary.

A program list display system (15) according to the present invention is characterized by being a program list display system, comprising a program data receiving device to receive program data of television broadcasts, a program list making device to make a program list based on the program data received by the program data receiving device and a display driving device to display the program list made by the program list making device on a display device, wherein the program list making device comprises a same event display device to display program slots which are display areas of the program list corresponding to multiple programs in the display form showing that the same event is broadcast, when the multiple programs broadcast the same event.

Using the above program list display system (15), multiple programs broadcasting the same event such as the same game in sports can be easily found, so that it becomes easy to make a selection from a wide range of programs.

A program list display system (16) according to the present invention is characterized by the same event display device, which produces a display showing the relationship of time sequence between the multiple programs broadcasting the same event in the above program list display system (15).

Using the above program list display system (16), the time relationship between multiple programs broadcasting the same event such as the same game in sports, for example, a relay broadcast wherein the same game of a sport is broadcast for the first 2 hours in Program A and then, until the end of the game in Program B, can be easily grasped, so that it becomes easy to certainly select a program.

A program list display system (17) according to the present invention is characterized by being a program list display system, comprising a program data receiving device to receive program data of television broadcasts, a program list making device to make a program list based on the program data received by the program data receiving device and a display driving device to display the program list made by the program list making device on a display device, wherein the program list making device comprises a time change display device to display program slots which are display areas of the program list corresponding to programs before and after changing the broadcast time in the display form showing that the programs are the same with a change in the broadcast time, when the program broadcast time is changed.

Using the above program list display system (17), a change in the broadcast time can be easily and reliably known, so that it becomes possible to certainly select a program.

A program list display system (18) according to the present invention is characterized by the time change display device, which produces a display showing a time direction in which the program time is changed in the above program list display system (17).

Using the above program list display system (18), it is possible to immediately find to what time the broadcast time is shifted through intuition, so that it becomes possible to quickly and certainly select a program.

A program list display system (19) according to the present invention is characterized by the time change display device, which displays an original program slot before a change in a quiet way in the above program list display system (17) or (18).

Using the above program list display system (19), an original program content is displayed in a quiet way in the time period when the program is not broadcast because of a change in the broadcast time, so that it is possible to prevent misidentification of program information and to reliably know that a change in time was given to the program.

A program list display system (20) according to the present invention is characterized by being a program list display system, comprising a program data receiving device to receive program data of television broadcasts, a program list making device to make a program list based on the program data received by the program data receiving device and a display driving device to display the program list made by the program list making device on a display device, wherein the program list making device comprises a serial program display device to display program slots which are display areas of the program list corresponding to parts of a serial program in the display form showing that the programs are parts of the serial program, when the serial program broadcasts an event in parts in point of time.

Using the above program list display system (20), it is possible to certainly grasp a serial program such as a serial drama broadcast every day or every week, so that it becomes possible to swiftly and reliably carry out a program selection such as reception programming or recording programming.

### BRIEF DESCRIPTION OF THE DRAWINGS

FIG. 1 is a block diagram schematically showing the construction of a digital television broadcast receiving set including a program list display system according to an embodiment of the present invention;

FIG. 2 is a flow chart showing the display processing of a program list performed by a microcomputer of the program list display system according to the embodiment;

FIG. 3 is an illustration showing a display example of a program list shown on a display;

FIG. 4 is an illustration showing a display example of a program list shown on the display;

FIG. 5 is an illustration showing a display example of a program list shown on the display; and

FIG. 6 is an illustration showing a display example of a program list shown on the display.

### DESCRIPTION OF THE PREFERRED EMBODIMENTS

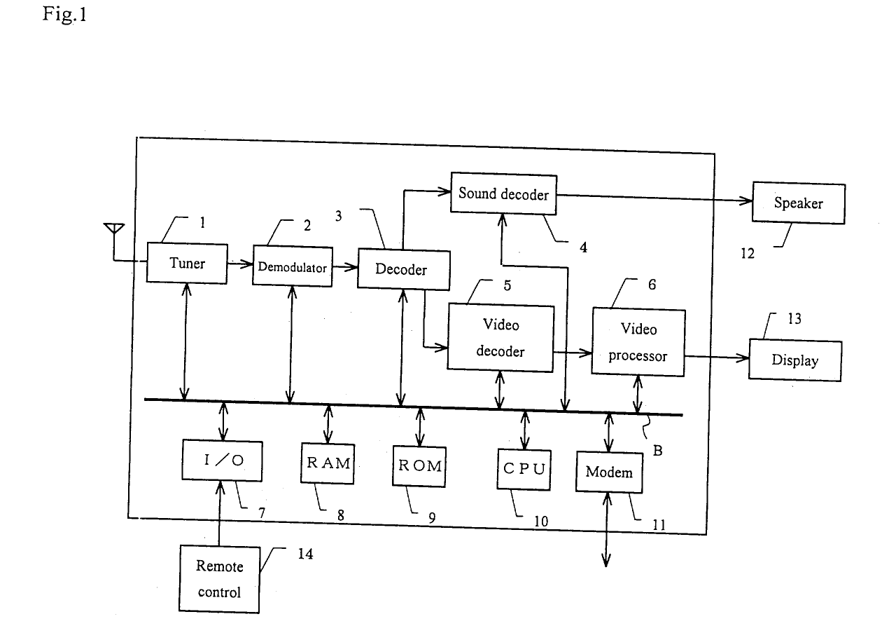

A program list display system according to the preferred embodiments of the present invention is described below. FIG. 1 is a construction diagram showing the construction of a digital television broadcast receiving set including a program list display system according to an embodiment.

Tuner 1 selectively receives a broadcast wave desired by a user from input radio waves received through an antenna and amplifies it, comprising a high-frequency amplifier circuit, a tuning circuit and the like. A demodulator 2 demodulates the received wave selectively received by the tuner 1 and outputs digital signals, comprising an OFDM demodulating circuit for OFDM demodulation of the OFDM-modulated broadcast wave, and the like in digital television broadcasting.

A decoder 3 decodes the OFDM-demodulated digital signals, or returns the digital signals on which transmission error prevention, compression, joining and the like were conducted before modulation in a broadcast station to their original digital signals, comprising a logical circuit, a digital signal processor and the like. And the digital signals decoded by the decoder 3 are output as sound data, video data, and processing and control data of various kinds each to a sound decoder 4, a video decoder 5, and a microcomputer (a bus line for data transmission). Here, EPG data (program data) contained in broadcast signals is output to the bus line B for data transmission.

The sound decoder 4 decodes the sound data from the decoder 3, or conducts digital processing such as data error decompression and expanding as opposed to the transmission error prevention, compression and the like which were conducted on the sound data so as to decompress its original sound data, comprising a logical circuit, a digital signal processor and the like. The sound signal output from the sound decoder 4 is output as a sound through a speaker 12 after digital-to-analog conversion and power amplification (not shown).

The video decoder 5 decodes the video data from the decoder 3, or conducts digital processing such as data error decompression and expanding as opposed to the transmission error prevention, compression and the like which were conducted on the video data so as to decompress its original video data, comprising a logical circuit, a digital signal processor and the like. On the video signal output from the video decoder 5, image quality processing such as brightness, contrast and hue, composing/switching processing with/to other images (an EPG etc.), and the like are conducted in a video processor 6 so as to be displayed on a display 13 comprising a liquid crystal display and the like. The video processor 6 includes a VRAM and outputs video signals to the display 13 based on data written in the VRAM. That is, by equalizing data written into the VRAM to data desired, it becomes possible to show desired images on the display 13.

It is the microcomputer that controls each kind of operation of the overall digital television broadcast receiving set, comprising a central processing unit (CPU) 10 which performs processing, a ROM 9 in which programs and various kinds of data are stored, a RAM 8 which temporarily stores various kinds of data, and the like. Here, to the RAM 8, backup power is provided even if a power switch is OFF, so as to hold data. And each component of the digital television broadcast receiving set is connected through the bus line B, so that data transmission to each other is possible.

A modem 11 is connected to the bus line B, so that the digital television broadcast receiving set enables communication with the outside such as communication with a digital television broadcast station, or connection to the Internet. For example, program data can be obtained through communication with a television broadcast station or from the contents of the Internet. Furthermore, an input/output interface (I/O) 7 is connected to the bus line B, so that connection with outer equipment is possible. For example, data of a remote control 14 using infrared rays or the like is captured so as to operate according to the data, so that a user can allow the digital television broadcast receiving set to perform desired operation by operating the remote control 14.

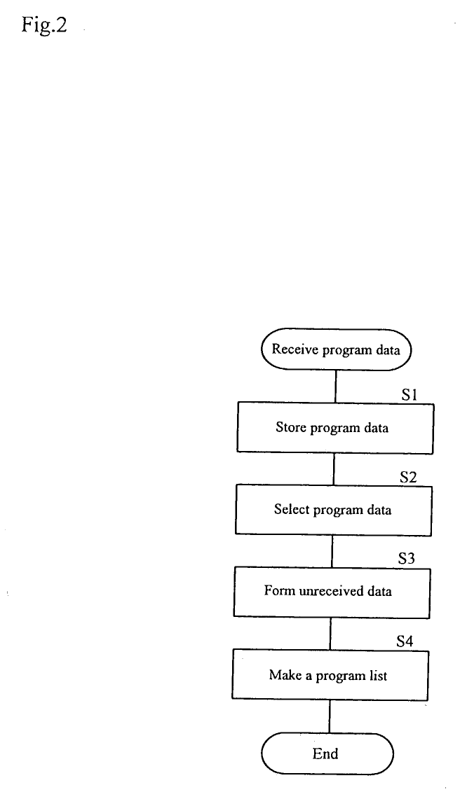

The display processing of a program list is described below. First, the outline of the overall display processing of an EPG is described by reference to a flow chart shown in FIG. 2. This display processing of a program list is conducted when program data is received.

In Step 1, received program data is stored in the RAM 8, and then the processing goes to Step 2. The storage of the program data into the RAM 8 in Step 1 is conducted by a system wherein only a portion different from the program data stored in the past is rewritten. This system adopted brings the program data stored in the RAM 8 up to date all the time, so that a program list is made based on the latest data. And the past data are held until an area for program data storage allocated to the RAM 8 is filled up, and then older program data is cleared so as to secure the storage area. The program data includes the program title, program contents, genre, broadcast time and the like.

In Step 2, program data at an appropriate date and time are selected and read out from the RAM 8 according to the date and time of a displayed EPG, and then the processing goes to Step 3. In Step 3, data unstored in the RAM 8, or unreceived program data, among the program data at the date and time required according to the date and time of the displayed EPG, is predicted and formed based on the past program data and the like, and it goes to Step 4. Here, the predictive formation of unreceived program data is described below with examples.

In Step 4, a program list is made based on the selected received data and the predictively formed program data, and is written into the VRAM, and then the processing is ended. The program list thus made is shown on the display 13. Though display examples of a program list are described below, the making of a program list comprises the processing wherein program slots are formed according to the time period of each program data in the displayed date and time periods and are filled with program titles, contents, marks, background images (background colors) of the corresponding programs to the program slots, the processing wherein a line, an arrow or the like is written into a desired portion of a picture after the former processing, and the like. Such processing is performed by processing the data written into the VRAM.

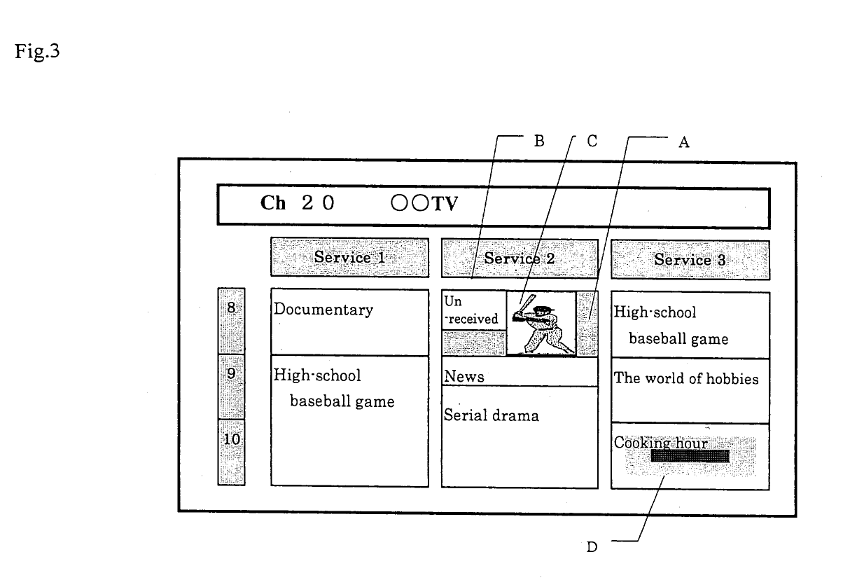

A display example of a program list is described below. FIG. 3 is an illustration showing a display example of a program list shown on the display 13. An in-reception channel number and its broadcast station name are shown in the top portion of the program list, while broadcast time periods are shown on the left side. Since multiple programs can be broadcast on one channel in the case of digital television broadcasting, three program columns (Services 1-3) are shown in this example. And in each program slot of each service, a program title corresponding to the program slot is shown.

Relating to details (performers or the genre) of a program, the area of its program slot is not sufficiently large to clearly show them. Therefore, they are shown on the program list at the instant when the program slot is selected and detailed display operation is conducted using the remote control 14. In this example, the program data corresponding to the 8 o'clock program slot in Service 2 has not been received yet, and the program slot is displayed differently from the other program slots. As the display methods, any of the below-described methods \mathring{1}-\mathring{3} can be used or these methods can be used in combination, and it is clearly shown that the program data of the program slot has not been received yet.

\mathring{1} Program data such as a program title of an unreceived program slot is not shown and the program slot is filled in with a background color A different from that of received program slots.

\mathring{2} A mark B showing that the program data has not been received is displayed in an unreceived program slot.

\mathring{3} An image C of a program which is being received and displayed is shown in an unreceived program slot. In this method, it is possible to make sure the program which is being received and displayed using a real image.

Concerning the 10 o'clock program slot in Service 3 which was changed from an unreceived program slot to a received program slot because of new program data, a flashing display of its background color is conducted (the color is switched at prescribed intervals) so as to enhance the reception of the program data. In another embodiment, a method wherein the background color is changed, a method wherein a mark is displayed or the like may be adopted, besides the flashing display of the background color. Or these methods may be adopted in combination. All the cases have the effect of enhancing the reception of the program data.

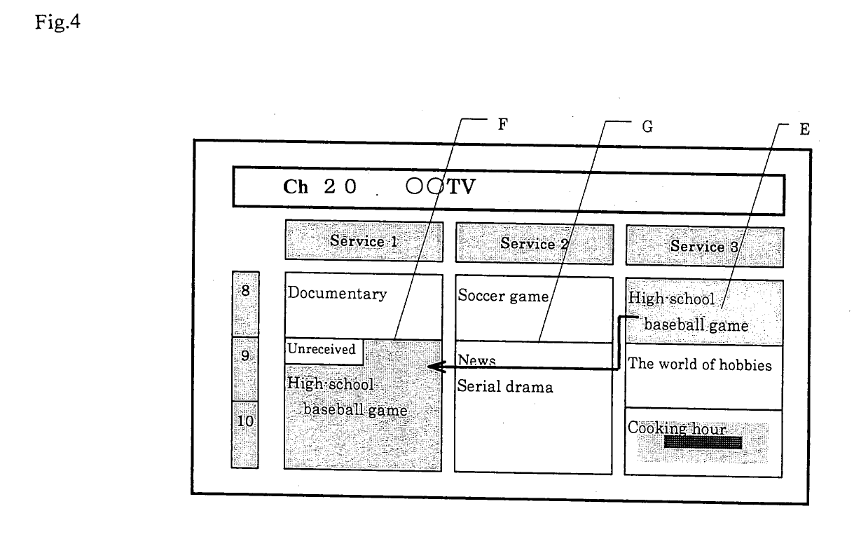

Another display example of a program list is described below. FIG. 4 is an illustration showing a display example of a program list shown on the display 13. Since the outline of the program list is similar to that of the program list shown in FIG. 3, it is not described here. In this example, there is a characteristic in the display form in cases where there are different programs relating to the same event, and the backgrounds of program slots E and F for those programs are filled in with a background color A different from that of the other program slots (the slots E and F are filled in with the same color). That is, the program slots E and F are displayed so as to show that the program slots E and F are filled with programs of the same event.

In another embodiment, prescribed marks may be displayed to show that the program slots E and F are filled with programs of the same event. Or these methods may be combined. An arrow G showing that a high-school baseball game (the same event) to be broadcast at 8 o'clock in Service 3 is to be successively broadcast (what is called a relay broadcast) at 9 o'clock in Service 1 is displayed in the program list. That is, a display showing a time relationship between programs broadcasting the same event is shown in the program list. As to the program slot F at 9 o'clock in Service 1, the program data thereof has not been perfectly received, so that the program data (the program title is displayed in the program list, and detailed information is displayed by a predetermined operation) is displayed based on the program data of the program slot E whose program data has been already received, and a mark indicating that is displayed.

Here, whether the same event is broadcast or not is judged from the identity of the event information and the program titles included in the program data, or relay broadcast data (data of the source or the target of the relay), but this judgment cannot be made at the instant when there is no program data received. Therefore, a relay broadcast display of the same event is displayed from the moment when (a portion of) the program data useful for judgment is received.

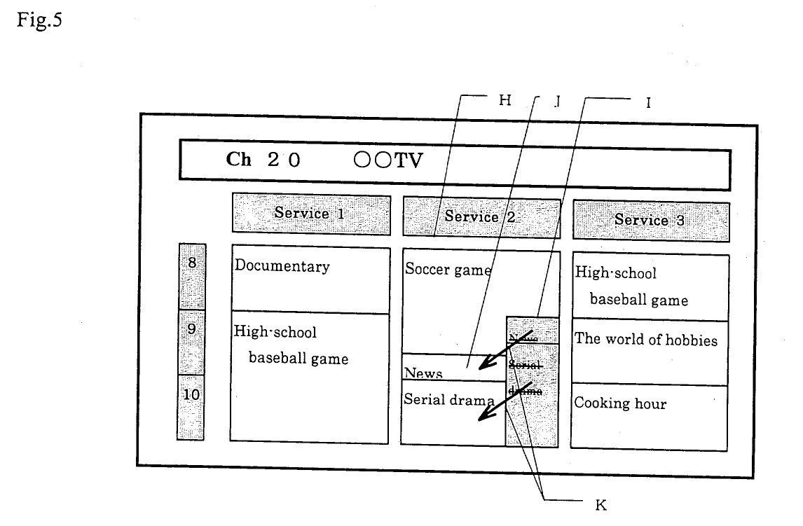

A still another display example of a program list is described below. FIG. 5 is an illustration showing a display example of a program list shown on the display 13. Since the outline of the program list is similar to that of the program list shown in FIG. 3, it is not described here. This example shows a display form in cases where the broadcast time of a certain program has been changed, or a soccer game program H broadcast at 8 o'clock in Service 2 was extended till 9:30, so that the following programs, a news program and a serial drama, were shifted by 30 minutes. The program slot 1 before the change has been reduced and moved to the right portion of the display column of Service 2, and its background color has been made a display color different from that of the other program slots, so that the program slot becomes less noticeable and it can be known that the program is a program before the change. And the characters and the like have been made semitransparent, which makes it easier to distinguish the program before the change. A program slot J after the change is relatively large in the left portion of the display column of Service 2, and its background color is a display color similar to that of the program slot before the change (for example, the same color but a little dark, with heavier frame lines or the like), so that the program slot becomes noticeable and it can be easily known that the program is a program after the change through the relationship with the program before the change. Furthermore, an arrow K showing the relationship between the programs before and after the change, or an arrow K showing the broadcast time of which program is changed to what time period is displayed, so that the changes in the programs are easy to know.

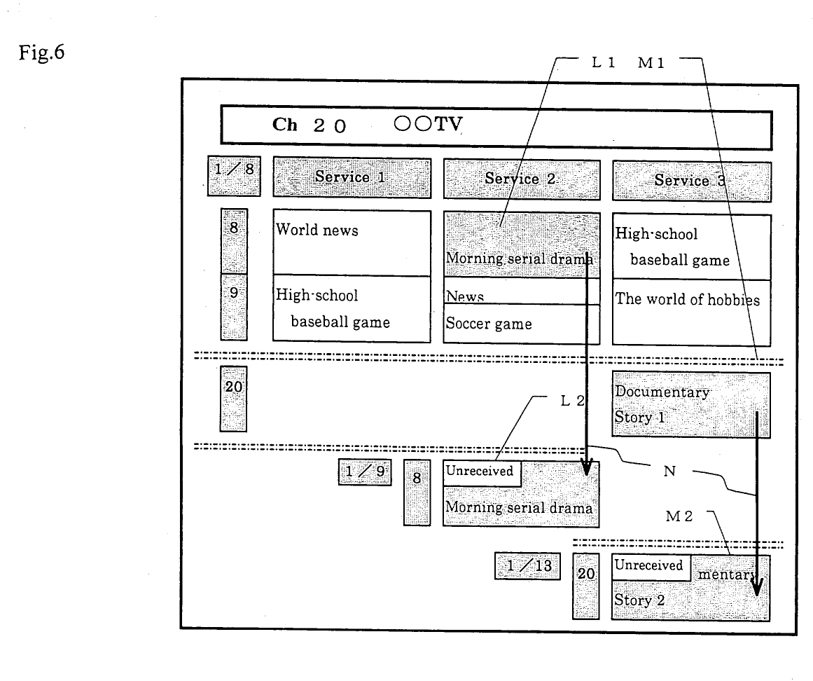

A still another display example of a program list is described below. FIG. 6 is an illustration showing a display example of a program list shown on the display 13. Since the outline of the program list is similar to that of the program list shown in FIG. 3, it is not described here. This example shows a display form of a serial program wherein a continued event is broadcast in parts in point of time, for example, a regular-time news program or a serial drama broadcast at a fixed time every day, or on Monday to Friday or Saturday, or a serial drama broadcast at a fixed time on a prescribed day every week. And in another embodiment, it is also possible to apply this form of display to regular-time programs which do not broadcast a continued event but have strong relations (movies or variety programs).

In the case of a serial program broadcasting a continued event (such as the same drama), the backgrounds of the program slots L1 and L2, or M1 and M2 are filled in with a background color A (the slots L are filled in with the same color) different from that of the other program slots. That is, it is shown that the program slots L1 and L2, or M1 and M2 are serials of the same event. In another embodiment, prescribed marks may be displayed to show that the program slots L1 and L2, or M1 and M2 are serials of the same event. And an arrow N showing the successiveness of the program slots L1 and L2 is displayed in the program list. That is, a display showing a time relationship between programs broadcasting a continued event is displayed in the program list. Here, as to the program slot L2 at 8 o'clock in Service 2, its program data has not been perfectly received yet, so that the program data (the program title is shown in the program list, and detailed information is displayed by a prescribed operation) is displayed based on the program data of the program slot L1 whose program data has been already received, and a mark indicating that is displayed.

Whether they are serials or not is judged from the identity of the event information and the program titles included in the program data, or serial program data (successive period data and broadcast time data), but this judgment cannot be made at the instant when there is no program data received. Therefore, a serial program display is displayed from the moment when (a portion of) the program data useful for judgment is received.

A method for predicting and forming program data from characteristics of program schedules in serial programs or strongly related regular-time programs (movies or variety programs) in cases where the program data has not been received yet is described below. A program list is made using such predictively formed program data.

As characteristics of program schedules, till 18:00 and after 23:00 on weekdays (Mon.-Fri.), there has been a very strong tendency to broadcast a program of similar contents with the same title (hereinafter, referred to as a same title program) at the same hour (hereinafter, referred to as the A time period) every day, while between 19:00 and 23:00 on weekdays, and on Saturday and Sunday (throughout the days) (hereinafter, referred to as the B time period), there has been a very strong tendency to broadcast a same title program on the same day every week. Therefore, in this embodiment, regarding a program whose program data has not been received yet, program data of a program in the A time period is predicted using program data at the same hour on another day (such as the preceding day on weekdays), while program data of a program in the B time period is predicted using program data at the same hour on the same day of another week (such as one week ago).

The program data for such prediction is stored in the RAM 8, and freshly received program data is always written over the program data stored in the RAM 8, resulting in a high accuracy of prediction. The program data for prediction is preferably program data on the closest day in point of time to the program targeted for prediction (one day ago (later), one week ago (later)). Here, as to the A and B time periods, when users can select them by operation of the remote control 14 or the like, it becomes possible to deal with more various program schedules. In this case, the selected data is stored in the RAM 8.

As described above, using the program list display system according to the embodiments of the present invention, program data can be predicted and formed with more high accuracy by appropriate estimate, even if the program data has not been received yet, so that an appropriate program list can be displayed promptly. And a program list which enables users to easily find predicted program information, serial programs, programs having a change in the broadcast time, relay programs and the like is displayed, resulting in a useful program display for users.

What is claimed is:

1. A program list display system, comprising:
a program data receiving device to receive program data of television broadcasts;
a program list making device to make a program list based on the program data received by the program data receiving device; and
a display driving device to display the program list made by the program list making device on a display device;
wherein the program list making device comprises an unreceived slot image formation device to form an unreceived slot image in an unreceived program slot which is a display area of the program list corresponding to an unreceived program whose program data has not been received so as to make a program list.

2. A program list display system according to claim 1, wherein the unreceived slot image is a picture filled in with a single color.

3. A program list display system according to claim 1, wherein the unreceived slot image is a television broadcast picture.

4. A program list display system according to claim 1, comprising a display form changing device to differentiate a display form of an unreceived program slot which is altered to a received program slot from that of other received program slots, when the unreceived program slot is altered to the received program slot which is a display area of the program list corresponding to a received program whose program data has been received, based on new program data received by the program data receiving device.

5. A program list display system according to claim 1, wherein the unreceived slot image is formed based on data of a received program which broadcasts the same event.

6. A program list display system according to claim 1, wherein the unreceived slot image is formed based on program data of one part of a serial program in another time period, when the serial program broadcasts an event in parts in point of time.

7. A program list display system according to claim 6, comprising a serial program display form changing device to differentiate a display form of a program slot corresponding to the unreceived slot image from that of other program slots, when the unreceived slot image is formed based on program data of one part of a serial program in another time period.

8. A program list display system according to claim 1, comprising:
a program data storage device to store program data; and
a serial program detecting device to detect a serial program based on the program data stored in the program data storage device.

9. A program list display system according to claim 1, comprising:
a program data storage device to store program data; and
an unreceived slot image predictive formation device to predict and form the unreceived slot image based on the program data stored in the program data storage device and the date and time of the unreceived slot.

10. A program list display system according to claim 9, wherein the unreceived slot image predictive formation device predicts and forms the unreceived slot image based on the latest program data stored in the data storage device.

11. A program list display system according to claim 9, wherein the unreceived slot image predictive formation device predicts and forms the unreceived slot image based on program data of a program at the same hour a prescribed number of days before the date of the unreceived slot.

12. A program list display system according to claim 11, wherein the prescribed number of days is determined according to the time period of the unreceived slot.

13. A program list display system according to claim 1, wherein the display form of the unreceived slot is different from that of the received slot.

14. A program list display system according to claim 1, wherein the unreceived slot image includes a mark showing that the program is an unreceived program.

15. A program list display system, comprising:
a program data receiving device to receive program data of television broadcasts;
a program list making device to make a program list based on the program data received by the program data receiving device; and
a display driving device to display the program list made by the program list making device on a display device;
wherein the program list making device comprises a same event display device to display program slots which are display areas of the program list corresponding to multiple programs in the display form showing that the same event is broadcast, when the multiple programs broadcast the same event.

16. A program list display system according to claim 15, wherein the same event display device produces a display showing the relationship of time sequence between the multiple programs broadcasting the same event.

17. A program list display system, comprising:
a program data receiving device to receive program data of television broadcasts;
a program list making device to make a program list based on the program data received by the program data receiving device; and
a display driving device to display the program list made by the program list making device on a display device;
wherein the program list making device comprises a time change display device to display program slots which are display areas of the program list corresponding to programs before and after changing the broadcast time in the display form showing that the programs are the same with a change in the broadcast time, when the program broadcast time is changed.

18. A program list display system according to claim 17, wherein the time change display device produces a display showing a time direction in which the program time is changed.

19. A program list display system according to claim 17, wherein the time change display device displays an original program slot before a change in a quiet way.

20. A program list display system, comprising:
a program data receiving device to receive program data of television broadcasts;
a program list making device to make a program list based on the program data received by the program data receiving device; and
a display driving device to display the program list made by the program list making device on a display device;
wherein the program list making device comprises a serial program display device to display program slots which are display areas of the program list corresponding to parts of a serial program in the display form showing that the programs are parts of the serial program, when the serial program broadcasts an event in parts in point of time.
